(19) United States
(12) Patent Application Publication
(10) Pub. No.: US 2005/0171908 A1
(43) Pub. Date: Aug. 4, 2005

(54) System and method for aggregating and delegating signature authority to third parties in commercial transactions

(76) Inventors: James Kenneth Carlsen, Santa Rosa, CA (US); Scott Andrew McClenahan, San Francisco, CA (US)

Correspondence Address: James K. Carlsen, 284 Alvarado Ave, Los Altos, CA, 94022, US

(21) Appl. No.: 11/046,345

(22) Filed: Jan. 29, 2005

Related U.S. Application Data
(60) Provisional application No. 60/540,175, filed on Jan. 29, 2004.

(51) Int. Cl. G06F 17/60

(52) U.S. Cl. 705/44

(57) ABSTRACT

The present invention comprises a computer network, a database, and multiple input-output ports whereby vendors and authorizing-companies share commercial information about the identity of third parties such as authorized buyers, authorized signers, and authorized agents, and various related information including levels and types of signature authority for these third parties. Networked I/O ports provide a means for communicating this information to and from the database by vendors and authorizing-companies.

### CROSS-REFERENCE TO RELATED APPLICATIONS

This application claims the benefit of PPA Ser. No. 60/540,175 filed 2004 January 29 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to signature authority in commercial transactions, specifically to an improved process of aggregating and automating the delegation of signature authority and permissions to employees in relation to their level of authorization to purchase goods or services.

2. Prior Art

In the normal course of commerce, individuals and organizations often delegate the authority or permissions for performing actions such as purchasing, signing of legal documents, negotiating, use of goods, and use of services to others (hereinafter called third parties). For example, many organizations utilize commercial accounts. A company (the vendor) often extends credit to a second company (the authorizing-company) so as to exchange goods and services on a regular basis without the use of cash or immediate account settlement. Third parties, usually employees of the authorizing-company, are often authorized to initiate orders, call in orders, and pick up orders. These third parties can also be non-employees such as delivery services, sub-contractors, relatives or friends authorized by the authorizing-company. These transactions can be done by one person or by several. The authority to perform such transactions is often called a “signature authority”. Presently, various methods are used to control a third party's signature authority with vendors. These include purchase orders, authorized buyer lists, signature authority lists, presentation of company identification, and informal identification such as recognition of a familiar voice over the phone or a familiar face across a counter.

One problem with current methods of controlling signature authority, is that employee status in authorizing-companies is constantly changing. This includes being promoted, demoted, reassigned, terminated, temporarily laid-off, going on medical leave, going on vacation, being resigned, etc. In addition, employees can be dishonest or misunderstand their status or scope of authority. This applies to both individuals and to groups, such as work crews. For non-employee third parties, the situation is equally fluid.

To this dynamic mix of people and groups, authorizing-companies then must give various and changing levels of signature authority to initiate orders, place orders, and pickup orders with vendors. The situation is ripe for confusion and dishonest behavior. For example, occasionally dishonest employees use their signature authority for personal gain, either by adding items for themselves to an otherwise legitimate order, or upon termination placing a large order on a vendor account for their own use.

In order to control this, most large authorizing-companies use purchase orders. Small and many mid-size authorizing-companies simply send letters to vendors with their “authorized buyer” lists. Each time an employee leaves or changes status, authorizing-companies must send a letter to every one of its vendors . . . often a long list. In lieu of letters, a long series of phone calls is often made. The vendors, in turn, are deluged with letters and calls and must incur the cost of processing these communications. To save time and money, many authorizing-companies ignore the issue of who is authorized to do or purchase what. They simply take their chances and hope for the best. In the event the authorizing-company receives a bad invoice they either pay it, or protest the charges to the vendor who typically ends up writing the invoice off and/or closing the account. Both solutions result in bad relations between authorizing-company and vendor, as well as financial loss for one or both parties.

The present invention automates these relationships by supplying a computer network, a database, and multiple input-output ports whereby vendors and authorizing-companies share commercial information about the identity of third parties such as authorized buyers, authorized signers, and authorized agents, and various related information including levels and types of signature authority. Prior art in this area concerns various pieces of the present invention but does not encompass the whole of it.

Much prior art exists concerning automating transactions between buyers and sellers, such as with credit card transactions. For example, U.S. Pat. No. 3,719,927 to Michaels, and U.S. Pat. No. 4,799,156 to Shavit disclose methods of on-line communication and processing of buyer-seller transactions such as with credit cards performed at the point of sale or in e-commerce, and with the movement of goods purchased in these transactions. The present invention, however, deals with the authentication of identity, the authorization of signature authority, and managing and communicating the level of signature authority to purchase goods and services by third parties. The present invention is not a device for conducting business transactions or processing payments on-line, but is a security method and system at the point of sale to help mitigate fraudulent transactions.

In addition, classical credit card mediated transactions generally involve a single credit providing entity such as a bank, whereas the present invention mediates transactions between a vendor and a multiplicity of private credit accounts, often called house accounts, provided by the authorizing-companies.

U.S. Pat. No. 5,850,446 to Berger discloses a method for secure electronic payment in exchange for goods and services purchased over a communication network. U.S. Pat. No. 6,078,902 to Schenkler discloses the use of a clearing house and cryptography for use in conducting on-line transactions. Although the present invention incorporates secure methods of communication, it involves the authentication of identity and the level of authorization of signature authority for the purposes of security at the point of sale.

There are also many examples of prior art methods for authenticating the identity of persons using memorized parameters such as with passwords, PIN numbers, or signature recognition. In addition there are many prior art methods of authenticating the identity of persons using tokens such as credit cards or smart cards. Prior art biometric methods are also well known. The present invention does make use of these methods for authenticating the identity of third parties in vendor/authorizing-company transactions. However, these methods encompass only part of the invention.

### OBJECTS AND ADVANTAGES

Accordingly, several objects and advantages of the present invention are that, most generally, it comprises a computer network, a database, and multiple input-output (hereinafter abbreviated I/O) ports whereby vendors and authorizing-companies share commercial information about the identity of third parties such as authorized buyers, authorized signers, and authorized agents, and share various related information including levels and types of signature authority for these third parties. The network connected I/O ports provide a means for communicating this information to and from the database by vendors and authorizing-companies.

More particularly, further objects and advantages of the present invention are that:

(a) It communicates these authorizations between individuals and/or organizations in a simpler, faster, and more efficient way than is presently done.

(b) It communicates these authorizations in a secure way.

(c) It has controlled access to information to the database, such that individuals or organizations accessing the database see and manipulate only information relevant to their own transactions.

(d) It has a plurality of I/O ports for accessing and changing the database, authenticating the identity of users, and recording and memorizing transaction details. These I/O ports could be computer terminals, web-based Internet terminals, or specialized input-output devices with embedded processing.

(e) It maintains a list in the database of exactly who has signature authority to engage in commercial transactions with vendors on behalf of authorizing-companies. It removes terminated employees from this list to facilitate the blocking of unauthorized transactions.

(f) If using the Internet as the network, it allows the authorizing-company to administer updates to the database in a secure manner via a web page interface. This allows for minimal employee workload, since multiple vendors could be notified of changes to the database simultaneously.

(g) If using the Internet as a network, it allows the vendor to enter data and interact with the database in a secure manner via a web page interface. This allows for simple, quick authentication of the identity of third party purchasers and maintains high confidence of the vendors in the veracity of each transaction.

(h) It authenticates the identity of third parties in such transactions. Identification is automated using appropriate I/O ports. The means for authentication of identity could range from picture IDs, signature recognition, passwords, pin number, token passing (i.e. electronic cards, smart cards), to biometric recognition.

(i) It provides for dynamic adjustment of complex levels of signature authority for third parties. For example, monetary limits for purchases, aggregate monetary limits for purchases, limits on which vendor the third party could utilize, limits on the type of material or service purchased, or limits on the time of day or date when third parties could utilize vendors. Indeed, very specific contractual requirements set between certain vendors and authorizing-companies could be incorporated into the database.

(j) It also allows easy additions, changes, or updates the database. These changes to the database are controlled by authenticating the identity of representatives and employees of both vendors and authorizing-companies in much the same way as authenticating the identity of third parties. In addition, it has a hierarchy of permissions for those representatives and employees wishing to change signature authority, level of signature authority, monetary limits, allowed relationships etc. This allows various management levels in vendor companies and in authorizing-companies to have different and hierarchical access to the database.

(k) It allows the tracking of authorizing-company buying habits by vendors. Further objects and advantages of this invention will become apparent from a consideration of the drawings and ensuing description.

### DETAILED DESCRIPTION—FIGS. 1, 2, AND 3—PREFERRED EMBODIMENT

A general view of the preferred embodiment of the present invention is shown in FIG. 1. An authorizing-company (11) via an I/O device (12) and a secure network (13) such as the internet, connects to a database (14), whereby authorizing-company (11) inputs information to database (14) pertinent to various employees and other agents of the authorizing-company authorized to conduct commercial transactions on behalf of the authorizing-company. A third party (10), who is presumably an employee or agent of authorizing-company (11) proposes a commercial transaction with a vendor (17). Vendor (17) via an I/O device (16) and a secure network (15) such as the internet, also connects to database (14). By accessing information in database (14), vendor (17) is able to ascertain the validity of the transaction proposed by third party (10).

A detailed view of the authorizing-company's part of the preferred embodiment of the present invention is shown in FIG. 2. Authorizing-company (11) via I/O device (12) and secure network (13), connects to database (14). Authorizing-company (11) is then authenticated and authorized to access database (14). Then, authorizing-company (11) creates or selects any global transaction parameters (25) it wants to require for commercial transactions with vendors, such as but not limited to; purchase order required, and purchase order required in a specific format. Authorizing-company (11) then selects and or inputs a third party name (26). The third party name is the name of the employee or agent authorized by authorizing-company (11) to engage in commercial transactions on behalf of the authorizing-company. Then authorizing-company (11) selects a third party action (27) such as add, change or delete the third party from database (14). Authorizing-company (11) then selects the type of commercial transaction to modify or view, either a vendor (28), a category (29) or a contract (30). If vendor (28) is chosen, a list of specific vendors is displayed. Authorizing-company (11) then selects a signature authority level for vendor (31) including but not limited to, monetary limits for purchases, aggregate monetary limits for purchases, limits on the type of material or service purchased or limits on the time of day or dates when third parties can utilize vendors. If authorizing-company (11) chooses category (29), a list of aggregates of vendors is shown. These aggregations could include but are not limited to all vendors located in a specific geographic area, all vendors that sell certain types of products, or all vendors the authorizing-company (11) has credit accounts with. Authorizing-company (11) then chooses a signature authority level for the category (32), including but not limited to selecting monetary limits for purchases, aggregate monetary limits for purchases, limits on the type of material or service purchased or limits on the time of day or date when third parties could utilize these aggregations of vendors. If authorizing-company (11) chooses contract (30), a list of contracts is displayed. These contracts comprise any contract or document requiring a signature. Authorizing-company (11) would then choose a signature authority level for the contract (33) including but not limited to, select monetary limits for contracts, aggregate monetary limits for contracts, limits on the type of material or service contracted, or limits on the time of day or date when third parties could execute contracts.

A detailed view of the vendor's part of the preferred embodiment of the present invention is shown in FIG. 3. Third party (10), who is presumably an employee or agent of authorizing-company (11), proposes a commercial transaction with vendor (17). Vendor (17) via I/O device (12) and secure network (13), connects to database (14). Vendor (17) is then authenticated and authorized to access database (14). Then, vendor (17) search's for any global transaction parameters as already determined by the authorizing-company (11), and a decision is made as to whether the proposed transaction meets a set of global parameters (44) such as but not limited to: purchase order required, and purchase order required in a specific format. If the global parameters are not met then the transaction is declined (49). If the global parameters are met then vendor (17) searches for the name of the third party (10) in database (14) as authorized by the authorizing-company (11). The system authenticates the identity of third party (10) at this time based on data provided in the database. Identity authentication could include but is not limited to a password, signature recognition, a pin number, a token such as a credit card or smart card, or biometric data. A decision is made as to whether the third party is allowed and his identity has been authenticated (45) to conduct transactions on behalf of authorizing-company (11). If third party (10) is not allowed to conduct transactions, or the identity of the third party cannot be authenticated, then the transaction is declined (49). If third party (10) is allowed and authenticated then vendor (17) searches to see if third party (10) is authorized for specific product lines as authorized by authorizing-company (11). A decision is made as to whether the third party is allowed to purchase a specific product line (46) proposed in the transaction. If third party (10) is not authorized to purchase the specific product line requested, then the transaction is declined (49). If third party (10) is authorized for the specific product line then vendor (17) searches for other transaction parameters authorized by authorizing-company (11). A decision is made as to whether third party (10) and the proposed transaction meets any other parameters (47) need to be met. If the transaction does not match these parameters then the transaction is declined (49). If the proposed transaction matches the other parameters then vendor (17) checks to see if the proposed transaction matches the dollar amount authorized (48) by authorizing-company (11). A decision is made as to whether the dollar amount of the transaction is commensurate with requirements set forth by the authorizing-company (11). This dollar amount could include, but is not limited to a specific amount for the proposed transaction or an aggregate amount of the current transaction combined with the amounts from previous transactions. If the dollar amount is not commensurate then the transaction is declined (49). If the dollar amount is commensurate then the transaction is approved (50).

### SUMMARY

In summary the present invention is a system and method for automating and controlling vendor/authorizing-company commercial transactions done by third party intermediaries. It does this by providing a networked secure database which aggregates and distributes information about the signature authority levels set by authorizing-companies whereby vendors can authenticate the identity and the level of signature authority of third parties in order to approve the purchase of goods or services on behalf of authorizing-companies.

### DRAWINGS—FIGURES

In the drawings, closely related items appearing in different figures have the same number.

FIG. 1 is an overview of the preferred embodiment of the present invention.

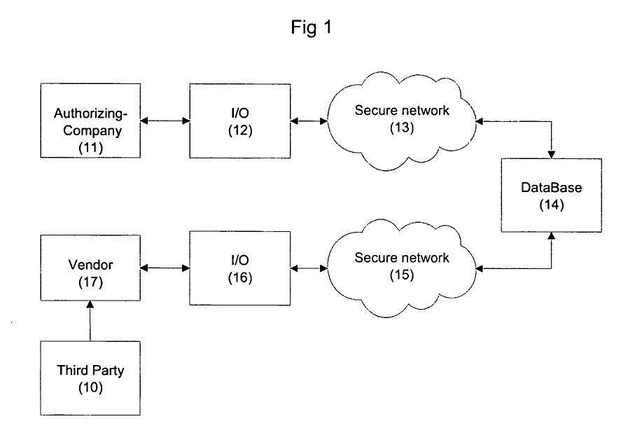

FIG. 2 shows details of the authorizing-company portion of the preferred embodiment.

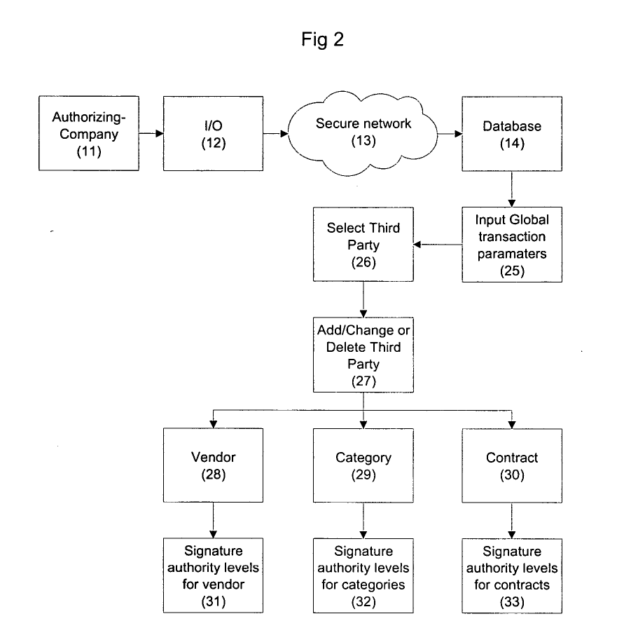

FIG. 3 shows details of the vendor portion of the preferred embodiment.

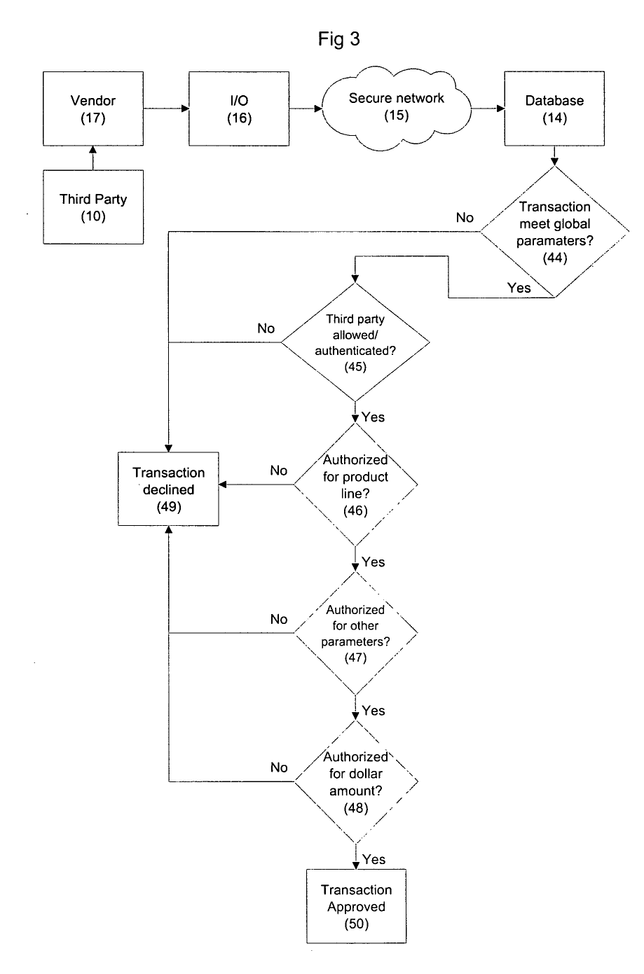

DRAWINGS-Reference Numerals

| | |
|---|---|
| 10 | Third Party |
| 11 | Authorizing-Company |
| 12 | I/O Port (for authorizing-company) |
| 13 | Secure Network (authorizing-company side) |
| 14 | Database |
| 15 | Secure Network (vendor side) |
| 16 | I/O Port (for vendor) |
| 17 | Vendor |
| 25 | Input Global Parameters |
| 26 | Select Third Party |
| 27 | Add/Change or Delete Third Party |
| 28 | Vendor |
| 29 | Category |
| 30 | Contract |
| 31 | Signature Authority Levels for Vendor |
| 32 | Signature Authority Levels for Categories |
| 33 | Signature Authority Levels for Contracts |
| 44 | Transaction Meets Global parameters? |
| 45 | Third Party Allowed/Authenticated? |
| 46 | Authorized For Product Line? |
| 47 | Authorized For Other Parameters? |
| 48 | Authorized For Dollar Amount? |
| 49 | Transaction Declined |
| 50 | Transaction Approved |

### CONCLUSIONS RAMIFICATIONS AND SCOPE

From the description above a number of advantages of the present invention become evident:

(a) It communicates signature authority between individuals and/or organizations in a simpler, faster, and more efficient way than done presently. By having one central repository for this information, vendors and authorizing-companies will have a streamlined, time & cost saving system.

(b) It streamlines the vendor/authorizing-company relationship and reduces the risk inherent in third party intermediated commercial transactions. Employee and other third party spending will be easier to control, and fraud can be greatly decreased resulting in reduced exposure for authorizing-company and vendor.

(c) It creates the above functionality without the added financial overhead inherent in classical credit card transactions.

(d) It is inherently secure by automatically and quickly ensuring the identity and signature authority level of third parties, and by ensuring the identity and database access authority of vendors and authorizing-companies and their representatives.

(e) It provides for dynamic adjustment of complex levels of signature authority for third parties and can be adapted to unique contractual requirements between vendor and authorizing-company.

(f) Authorizing-company loyalty to a given vendor is increased due to easier and more flexible transactions. In addition, there is less authorizing-company/vendor conflict due to reduced fraudulent transactions.

(g) It allows for targeted promotions with the ability to track buying habits.

(h) It increases the potential for lower pricing due to lower vendor expenses from reduced fraud and increased vendor margins from a reduction in credit card use.

While the above description contains many specificities, these should not be construed as limitations on the scope of the invention, but rather as an exemplification of one preferred embodiment thereof. For example, other networking systems besides the Internet could be used. The database could be physically located on several computers and be distributed about the network. The database could be controlled by a party separate from the vendor and authorizing-company, or by the vendor, or by the authorizing-company, or a combination thereof. The network interface could something other than a web page interface. For example it could comprise a custom keypad, embedded computer, and biometric reader connected directly to the network. In addition, the vendor and authorizing-company could be entities under the umbrella of one larger company. That is, the present invention could also be used to enhance third party transactions contained solely within a larger organization. Also, not only can goods and services be mediated by the present invention, but also other commercial transactions that use signature authority such as in the signing of contracts by third parties on behalf of authorizing-companies.

1. A method for automating and controlling vendor/authorizing-company commercial transactions done by third party intermediaries comprising:
a. Providing a computer database where said database comprises information about the identities of said third parties and about the authority of said third parties to conduct commercial transactions on behalf of said authorizing-companies; and
b. Providing a computer network which provides communication between said vendors, said authorizing-companies, and said database; and
c. Providing a plurality of input-output ports connected to said network allowing communication between said vendors and said authorizing-companies to said network;
whereby said vendors can determine whether said third parties are approved to execute commercial transactions on behalf of said authorizing-companies.

2. A method as in claim 1 where said commercial transactions are the purchase of goods or services.

3. A method as in claim 1 where said commercial transactions are the execution or signing of contracts.

4. A method as in claim 1 where said database also contains information about authenticating the identities of said third parties.

5. A method as in claim 1 where said database also contains information about the type and level of signature authority said third parties have with said authorizing-companies.

6. A method as in claim 1 where said network comprises the Internet.

7. A method as in claim 1 where the identity of vendor representatives and the identity of authorizing-company representatives accessing said database are authenticated.

8. A method as in claim 1 where said database resides on a computer server and is managed independently from said vendors and said authorizing-companies.

9. A method as in claim 1 where said database resides on a multiplicity of computer servers and is managed by said authorizing companies.

10. A method as in claim 1 where said third parties comprise individual employees, contractors, or agents of said authorizing-companies.

11. A method as in claim 1 where said third parties comprise a multiplicity of individuals employed or contracted by said authorizing-companies.

12. A method as in claim 4 where the identity of said third party is authenticated with a biometric identification means.

13. A method as in claim 4 where the identity of said third party is authenticated with a password, pin number, or signature recognition means.

14. A method as in claim 4 where the identity of said third party is authenticated with a token carried by said third party such as a credit card, smart card, or photo ID.

15. A method as in claim 5 where said database stores and communicates monetary limits for transactions between said vendor and said authorizing-company.

16. A method as in claim 15 where said monetary limits depend on the identity of said third party.

17. A method as in claim 15 where said monetary limits depend on an aggregate amount spent by said third party over a certain time span.

18. A method as in claim 5 where the authority to purchase particular types or quantities of goods or services by said third party is limited.

19. A method as in claim 5 where the authority to execute or sign particular types of contracts or contracts with particular monetary limits by said third party is limited.

20. A method as in claim 1 where the authority to do a transaction by said third party is limited to certain times or to certain days.

21. A method as in claim 1 where the authority to do a transaction by said third party is limited to certain vendors.

22. A system for automating and controlling vendor/authorizing-company commercial transactions done by third party intermediaries comprising:
a. A computer database where said database comprises information about the identities of said third parties and about the authority of said third parties to conduct commercial transactions on behalf of said authorizing-companies; and
b. A computer network which provides communication between said vendors, said authorizing-companies, and said database; and
c. A plurality of input-output ports connected to said network allowing communication between said vendors and said authorizing-companies to said network;
whereby said vendors can determine whether said third parties are approved to execute commercial transactions on behalf of said authorizing-companies.

23. A system as in claim 22 where said commercial transactions are the purchase of goods or services.

24. A system as in claim 22 where said commercial transactions are the execution or signing of contracts.

25. A system as in claim 22 where said database also contains information about authenticating the identities of said third parties.

26. A system as in claim 22 where said database also contains information about the type and level of signature authority said third parties have with said authorizing-companies.

27. A system as in claim 22 where said network comprises the Internet.

28. A system as in claim 22 where the identity of vendor representatives and the identity of authorizing-company representatives accessing said database are authenticated.

29. A system as in claim 22 where said database resides on a computer server and is managed independently from said vendors and said authorizing-companies.

30. A system as in claim 22 where said database resides on a multiplicity of computer servers and is managed by said authorizing companies.

31. A system as in claim 22 where said third parties comprise individual employees, contractors, or agents of said authorizing-companies.

32. A system as in claim 22 where said third parties comprise a multiplicity of individuals employed or contracted by said authorizing-companies.

33. A system as in claim 25 where the identity of said third party is authenticated with a biometric identification means.

34. A system as in claim 25 where the identity of said third party is authenticated with a password, pin number, or signature recognition means.

35. A system as in claim 25 where the identity of said third party is authenticated with a token carried by said third party such as a credit card, smart card, or photo ID.

36. A system as in claim 26 where said database stores and communicates monetary limits for transactions between said vendor and said authorizing-company.

37. A system as in claim 36 where said monetary limits depend on the identity of said third party.

38. A system as in claim 36 where said monetary limits depend on an aggregate amount spent by said third party over a certain time span.

39. A system as in claim 26 where the authority to purchase particular types or quantities of goods or services by said third party is limited.

40. A system as in claim 26 where the authority to execute or sign particular types of contracts or contracts with particular monetary limits by said third party is limited.

41. A system as in claim 22 where the authority to do a transaction by said third party is limited to certain times or to certain days.

42. A system as in claim 22 where the authority to do a transaction by said third party is limited to certain vendors.
